(19) United States
(12) Patent Application Publication
(10) Pub. No.: US 2021/0056437 A1
(43) Pub. Date: Feb. 25, 2021

(54) SYSTEMS AND METHODS FOR MATCHING USERS AND ENTITIES

(71) Applicant: SparkBeyond Ltd., Natanya (IL)

(72) Inventors: Shiri Simon-Segal, Tel-Aviv (IL); Raz Alon, Petach-Tikva (IL); Guy Shaked, Tel-Aviv (IL); Meir Maor, Netanya (IL); Amir Ronen, Haifa (IL); Ron Karidi, Herzliya (IL); Sagie Davidovich, Zikhron-Yaakov (IL); Elad Shaked, Haniel (IL)

(73) Assignee: SparkBeyond Ltd., Natanya (IL)

(21) Appl. No.: 16/550,233

(22) Filed: Aug. 25, 2019

(51) Int. Cl. G06N 5/02; G06F 16/28; G06Q 30/02

(52) U.S. Cl. CPC G06N 5/02; G06Q 30/0201; G06F 16/288

(57) ABSTRACT

There is provided a method of selecting subpopulations of users mapped to subpopulations of entities, comprising: receiving latent factors of a mapping between users and entities and a predicted correlation value for each undefined mapping, computed by a recommender process, for each respective latent factor: identifying, by a user semantic model, user features of the users correlated to the respective latent factor, identifying, by an entity semantic model, entity features of the entities correlated to the respective latent factor, generate combinations of pairs each including one user feature and one entity feature, for each pair, compute statistical metric(s) indicative of a change relative to the predicted correlation value for the users and the entities, select pair(s) according to a requirement of the statistical metric(s), and provide the user feature and the entity feature for each selected pair.

### FIELD AND BACKGROUND OF THE INVENTION

The present invention, in some embodiments thereof, relates to recommender systems and, more specifically, but not exclusively, to systems and methods for matching users and entities.

Recommender systems analyze patterns of users' interest in items, to provide personalized recommendations. For example, Collaborative Filtering for Recommender Systems, as described with reference to Yehuda Koren, Robert Bell and Chris Volinsky (2009). MATRIX FACTORIZATION TECHNIQUES FOR RECOMMENDER SYSTEMS. IEEE Computer Society, analyzes relationships between users, and interdependencies among items, to identify new user-item associations.

### SUMMARY OF THE INVENTION

According to a first aspect, a method of selecting subpopulations of users mapped to subpopulations of entities, comprises: receiving a plurality of latent factors of a mapping between a plurality of users and a plurality of entities and a predicted correlation value for each undefined mapping, computed by a recommender process, for each respective latent factor: identifying, by a computed user semantic model, a plurality of user features of the plurality of users correlated to the respective latent factor, identifying, by a computed entity semantic model, a plurality of entity features of the plurality of entities correlated to the respective latent factor, generate combinations of pairs each including one user feature and one entity feature, for each pair, computing at least one statistical metric indicative of a change relative to the predicted correlation value for the plurality of users and the plurality of entities, selecting at least one pair according to a requirement of the at least one statistical metric, and providing the user feature and the entity feature for each selected at least one pair.

According to a second aspect, a system for selecting subpopulations of users mapped to subpopulations of entities, comprises: at least one hardware processor executing a code for: receiving a plurality of latent factors of a mapping between a plurality of users and a plurality of entities and a predicted correlation value for each undefined mapping, computed by a recommender process, for each respective latent factor: identifying, by a computed user semantic model, a plurality of user features of the plurality of users correlated to the respective latent factor, identifying, by a computed entity semantic model, a plurality of entity features of the plurality of entities correlated to the respective latent factor, generate combinations of pairs each including one user feature and one entity feature, for each pair, computing at least one statistical metric indicative of a change relative to the predicted correlation value for the plurality of users and the plurality of entities, selecting at least one pair according to a requirement of the at least one statistical metric, and providing the user feature and the entity feature for each selected at least one pair.

According to a third aspect, a method of selecting subpopulations of users mapped to subpopulations of entities, comprises: receiving a mapping between plurality of user latent factors of a plurality of users and a plurality of entity latent factors of a plurality of entities and a predicted correlation value for each undefined mapping, computed by a recommender process, clustering users to create clusters of users according to corresponding user latent factors, clustering entities to create clusters of entities according to corresponding entity latent factors, identifying a plurality of user features common to users of each cluster of users, identifying a plurality of entity features common to entities of each cluster of entities, identifying pairs according to correlations between clusters of users and clusters of entities, each pair including a certain cluster of users and a certain cluster of entities, selecting at least one pair, and providing at least one user feature and at least one entity feature for each selected at least one pair.

In a further implementation of the first, and second aspects, the at least one statistical metric is computed as a change in a mean of the correlation value computed for a subset of the plurality of users and a subset of the plurality of entities for which the user feature and entity feature of the respective pair are true, relative to the plurality of users and the plurality of entities.

In a further implementation of the first, and second aspects, the at least one statistical metric is computed as a percentage of a subset of the plurality of users for which the user feature of the respective pair are true.

In a further implementation of the first, and second aspects, the at least one statistical metric is computed as a percentage of a subset of the plurality of entities for which the entity feature of the respective pair are true.

In a further implementation of the first, and second aspects, the at least one statistical metric is computed as a difference between a correlation value of the user to entities with the entity features of the respective pair, and a correlation value of the user to other entities that exclude the entity features of the respective pair.

In a further implementation of the first, and second aspects, the at least one statistical metric is computed as a difference between a correlation value of the entity among the users with the user features of the respective pair, and a correlation value of the entity amount other users excluding the user features of the respective pair.

In a further implementation of the first, and second aspects, further comprising: receiving a target user feature denoting a subpopulation of users, identifying a subset of the at least one pair including the target user feature, and providing at least one target entity feature from the identified subset.

In a further implementation of the first, and second aspects, further comprising: receiving a target entity feature denoting a subpopulation of entities, identifying a subset of the at least one pair including the target entity feature, and providing at least one target user feature from the identified subset.

In a further implementation of the first, and second aspects, further comprising: receiving an indication of a new user, feeding the indication of the new user into the user semantic model for prediction a value of the respective latent factor, computing a new correlation value for a mapping between the new user and an existing entity, by feeding the prediction of the value of the respective latent factor as input into the recommender process.

In a further implementation of the first, and second aspects, further comprising: receiving an indication of a new entity, feeding the indication of the new entity into the entity semantic model for prediction of a value of the respective latent factor, computing a new correlation value for a mapping between the new entity and an existing user, by feeding the prediction of the value of the respective latent factor as input into the recommender process.

In a further implementation of the first, and second aspects, further comprising: receiving an indication of a new user, feeding the indication of the new user into the user semantic model for prediction a value of the respective latent factor, receiving an indication of a new entity, feeding the indication of the new entity into the entity semantic model for prediction of a value of the respective latent factor, computing a new correlation value for a mapping between the new user and the new existing entity, by feeding the prediction of the value of the respective latent factor as input into the recommender process.

In a further implementation of the first, and second aspects, the plurality of latent factors include a plurality of user latent factors computed by the recommender process for the plurality of users and a plurality of entity latent factors computed by the recommender process for the plurality of entities, for each respective user latent factors of the plurality of user latent factors, computing the user semantic model for prediction of the respective user latent factor, for each respective entity latent factors of the plurality of entity latent factors, computing the entity semantic model for prediction of the respective entity latent factor, mapping the plurality of user latent factors to the plurality of entity latent factors, wherein the combination of pairs are generated for each of the plurality of latent factors mapping between a certain user latent factor and a certain entity latent factor.

In a further implementation of the first, and second aspects, further comprising, for each respective latent factor: computing a respective correlation value for each one of the plurality of user features and the respective latent factor, selecting a subset of the plurality of user features according to a requirement of the respective correlation value, computing a correlation value for each one of the plurality of entity features and the respective latent factor, selecting a subset of the plurality of entity features according to a requirement of the respective correlation value, wherein the combinations of pairs are generated from the selected subset of the plurality of entity features and the subset of the plurality of user features.

In a further implementation of the first, and second aspects, the correlation value predicted by the recommender process is selected from the group consisting of: a rating value assigned by the target user to the target entity, amount of purchases over a historical time interval by the target user of the target entity, value of purchases over a historical time interval by the target user of the target entity, number of clicks by the target user of a link and/or web page associated with the target entity.

In a further implementation of the first, and second aspects, the mapping includes predefined correlation values associated with the mapping of the plurality of users to the plurality of entities, and the recommender system is trained to predict the correlation values for undefined mappings.

In a further implementation of the first, and second aspects, the plurality of entities are selected from the group consisting of: a physical object, an item, a service, a computational resource, a network resource, a product, a cellular plan, a loan, a mortgage, an insurance policy, a stock, a website, a link to a web site, and an advertisement.

In a further implementation of the first, and second aspects, the plurality of user features for users representing human or organizations are selected from the group consisting of: demographic data, geographic living location, geographic job location, purchase pattern of certain items, occupation, age, education level, consumer behavior history, socio-economic background, social media activity, social network characteristics, geographic location, city, neighborhood, proximity to different places, number of employees, physical store size, seniority, performance, and domain expertise, wherein the plurality of user features for users representing automated code based processes are selected from the group consisting of: executing processor model, complexity of code, network address, memory requirements, network bandwidth requirements.

In a further implementation of the first, and second aspects, the plurality of entity features are selected from the group consisting of: size of an item, categorical description, genre, price, prestige, promotion, physical size, materials, flavors, manufacturing date, country of manufacture, design, duration of service or program, type of service or program, topic of service or program, processor availability, processor model, memory availability, and network bandwidth availability.

In a further implementation of the third aspect, the users are clustered to create clusters of users according to correlations between each user and entities, and the entities are clusters to create clusters of entities according to correlations between each entity and users.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method of selecting subpopulations of users mapped to subpopulations of entities, in accordance with some embodiments of the present invention;

FIG. 2 is a block diagram of components of a system for selecting subpopulations of users mapped to subpopulations of entities, in accordance with some embodiments of the present invention;

FIG. 3 is a flowchart of another method of selecting subpopulations of users mapped to subpopulations of entities, in accordance with some embodiments of the present invention;

FIG. 4 is a table depicting exemplary user features computed for users correlated to latent factor 5 by a computed user semantic model, and another table depicting exemplary entity features computed for entities correlated to latent factor 5 by a computed entity semantic model, in accordance with some embodiments of the present invention; and

FIG. 5 is a table of pairs each including a certain user feature and a certain entity feature, in accordance with some embodiments of the present invention.

### DESCRIPTION OF SPECIFIC EMBODIMENTS OF THE INVENTION

The present invention, in some embodiments thereof, relates to recommender systems and, more specifically, but not exclusively, to systems and methods for matching users and entities.

An aspect of some embodiments of the present invention relates to systems, an apparatus, methods, and/or code instructions (e.g., stored on a data storage device and executable by one or more hardware processors) for matching between a subpopulation of user mapped and a subpopulation of entities, and/or for predicting correlations between users and entities. The correlations may represent, for example, the subpopulation of entities that are predicted to be selected by the subpopulation of users, and/or the subpopulation of users for which the subpopulation of entities is most suitable. The users may relate to, for example, human users and/or automated code processes. The entities may relate to, for example, physical objects, virtual objects, and/or computational resources. Latent factors are received. The latent factors may be computed by a recommender process.

The latent factors are computed for mappings between multiple users and multiple entities. A predicted correlation value is computed for each undefined mapping, for example, when no value indicative of the mapping between a certain user and a certain entity is available. For respective latent factor, multiple user features of the users correlated to the respective latent factor are identified, optionally by a computed user semantic model. The user semantic model may compute user latent factors. Multiple entity features of the multiple entities correlated to the respective latent factor are identified, optionally by a computed entity semantic model. The entity semantic model may compute entity latent factors. The user latent factors are mapped to the entity latent factors (e.g., in the same space), where each mapping between a certain user latent factor and a corresponding entity latent factor represents a certain latent factor as described herein.

Combination of pairs, each including one user feature and one entity feature, are generated from the identified user features and entity features. For each pair, one or more statistical metrics are computed. Each statistical metric is indicative of a change relative to the predicted correlation value or the users and entities. One or more pairs are selected according to a requirement of the statistical metric(s). The user feature and/or the entity feature are provided for each selected pair. A certain (i.e., new and/or existing) user having the user feature may be predicted to correlate to a certain (i.e., new and/or existing) entity having the entity feature, for example, the certain user is predicted to select and/or assign a high rating to the certain entity. Alternatively or additionally, in another example, the certain entity is predicted to be selected and/or assigned a high rating by the certain user. Optionally, a certain user having the user feature is predicted to correlate to a certain entity having the entity feature

As used herein, the term matching (e.g., between users and entities) may sometimes refer to predicting correlations (e.g., between the users and entities).

An aspect of some embodiments of the present invention relates to systems, an apparatus, methods, and/or code instructions (e.g., stored on a data storage device and executable by one or more hardware processors) for selecting a subpopulation of user and a subpopulation of entities. Latent factors are received. The latent factors include user latent factors computed for the users, and entity latent factors computed for the entities. The user latent factors are mapped to the entity latent factors (e.g., in the same space), where each mapping between a certain user latent factor and a corresponding entity latent factor represents a certain latent factor as described herein.

The latent factors may be computed by a recommender process. The latent factors are computed for mappings between multiple users and multiple entities. A predicted correlation value is computed for each undefined mapping, for example, when no value indicative of the mapping between a certain user and a certain entity is available. The mappings include predefined mappings, for example, correlation values indicative of correlations between user and entities. Users are clusters to create clusters of users. The clustering into the clusters of users may be performed using the user latent factor representation and/or by correlation values of the users to entities.

The clustering into the clusters of entities may be performed using the entity latent factor representation and/or by correlation values of the entities to users. User features explaining user cluster assignment are identified for each user cluster, for example, the user features most common to the users assigned to the respective user cluster. Entity features explaining entity cluster assignment are identified for each entity cluster, for example, the entity features most common to the entities assigned to the respective entity cluster. Pairs, each including one cluster of users and one cluster of entities are indentified according to a correlation between the user clusters and entity clusters. Correlation may be positive or negative, for example, shortest (or longest) statistical distance between a certain user cluster and a certain entity cluster. One or more pairs may be selected. For each selected pair, the user feature(s) and entity feature(s) are provided, for example, the top ranked user features and entity features are provided.

At least some implementations of the systems, methods, apparatus, and/or code instructions (i.e., stored on a memory, executable by at least one hardware processor) described herein improve the technology of computational resource management, for improving optional and/or efficiency use of limited computational resources used by executing code based processes, for example, network resources (e.g., bandwidth), storage resources (e.g., memory, data storage devices), and/or computing resources (e.g., processor utilization), for example, in a multi-processor (e.g., single processor with multiple cores) and/or parallel processing environment and/or in a distributed system and/or in a network based computational platform (e.g., blockchain).

At least some implementations described herein predict optimal correlations between computational processes and computational resources for executing the computational processes. The users as described herein may refer to the executing code based processes, for example, applications, code on servers, client code, and low level code (e.g., kernel). The entities as described herein may refer to the limited computational resources used by the code based processes. At least some implementations of the systems, methods, apparatus, and/or code instructions described herein improve mapping between and/or predictions of correlations between the limited computational resources and the code based processes, which optimizes use of the limited computational resources.

At least some implementations of the systems, methods, apparatus, and/or code instructions (i.e., stored on a memory, executable by at least one hardware processor) described herein improve the technology of automated recommender processes, such as collaborative filtering. The improvement may be based on a solution to the technical problem of standard recommender systems provided by at least some implementations of the systems, methods, apparatus, and/or code instructions described herein. At least some implementations of the systems, methods, apparatus, and/or code instructions described herein compute user features (representing a subpopulation of users) that are statistically significantly correlated with entity features (representing a subpopulation of entities), in contrast to standard recommender processes that predict a mapping between an individual user and an individual entity. At least some implementations of the systems, methods, apparatus, and/or code instructions described herein identify subpopulations of user-entity pairs together with the description of their common characteristics (e.g. demographic, behavior and/or contextual) for which the correlation (e.g., preference) of the users to the entity is statistically significant and/or above a threshold and/or at a higher level relative to a requirement.

Standard recommender processes analyze patterns of users mapped to entities (e.g., user ratings of items) to predict mappings of users to entities when such mappings are not defined, for example, to predict how a certain user will rate a certain item when the user has not yet provided a rating for the item. Such standard recommender processes may predict mappings between individual users and individual entities, but are unable to predict mappings between subpopulations of users as defined by one or more user features with subpopulations of entities as defined by one or more entity features. At least some implementations of the systems, methods, apparatus, and/or code instructions described herein provide such mappings between user features and entity features. Standard recommender systems predict mappings between users and entities, but do not provide details on why such mappings are predicted. In contrast, at least some implementations of the systems, methods, apparatus, and/or code instructions described herein provide evidence as to why a certain entity should be recommended to a certain user, by identifying mappings between features of the recommended entity that are statistically significantly correlated with features of the certain user.

It is noted that some implementations of recommender processes, such as the collaborative filtering approach, is based on latent-factor models which aim to represent a user's correlation (e.g., preference for) with an entity by decomposing entities and users to a number of factors (i.e., latent factors) inferred from the inputted preference patterns. However, the latent factors, which represent an abstract reduction in dimensionality, cannot be directly translated into useful features by standard approaches. At least some implementations of the systems, methods, apparatus, and/or code instructions described herein translate the latent factors into the pairs of a user feature and entity feature that are statistically significantly correlated to one another.

The output provided by at least some implementations of the systems, methods, apparatus, and/or code instructions described herein may be used, for example, to identify market levers, and ultimately apply macro actions upon user and/or entity (e.g., item) subpopulations, rather than on individuals, in a personalized fashion only. For example, based on the data that a subpopulation of customers purchased some furniture in the past month, it is predicted that the subpopulation is more likely to purchase items for house renovation this month. Such information might drive the relevant business to promote renovation items within the customer subpopulation. Other macro actions may include, for example, planning better campaigns and/or designing dedicated items for specific users, based on the surfaced evidence. In addition, recommendations accompanied by interpretable evidence provide a better understanding of the recommendation rational and, as a result, increase the trust in the underlying model that produced those recommendations.

For example, the following represent exemplary pairs (computed by at least some implementations of the systems, methods, apparatus, and/or code instructions described herein) that have a high correlation between the respective user feature and entity feature, e.g., a high preference of users having the respective user feature to entities having the respective entity features. The user feature is on the left side of the comma, in italics, and the entity feature is on the right side of the comma in bold:

(The user lives<100 m from a store and purchases daily, The item is in small single packs)

(The user is a writer or an artist, The item is an old documentary film)

In another example, pairs having low correlation between the respective user feature and entity feature may be computed by at least some implementations of the systems, methods, apparatus, and/or code instructions described herein, such as:

(The user parked his/her bicycle near the store entrance, The item is in a large pack)

(The user is in elementary school, The item is an old documentary film)

Using the features (e.g., characteristics description) of user-entity pairs and associated computed value of statistical metrics (e.g., that describe the change in correlation (e.g., preference-level) relative to the entire user and entity populations), pairs of corresponding users and entities may be selected for targeting (e.g., by a business). Moreover, using the identified pairs, macro actions may be designed to accommodate the users and/or the business needs. The user-entity affinity computed by standard recommender processes may be interpreted by the pairs of user features correlated with entity features. For example, the statistically significant (e.g., value above a threshold and/or high based on a requirement) correlation among the following descriptive user-item pair: (The user lives<100 m from a store and purchases daily, The item is in small single packs) enables designing one or more of the following actions:
Open store branches with small-pack items in dense neighborhoods with frequent customer visits.
Increase the diversity and/or manufacture more items available in small packs among stores in dense neighborhoods with frequent customer visits.

At least some implementations of the systems, methods, apparatus, and/or code instructions described herein operate differently, and/or provide improvements, over other standard approaches for finding segments of users and entities based on observed data and/or latent factor representation. For example:
Reinhard Heckel, Michail Vlachos, Thomas Parnell, Celestine Duenner (2017) Scalable and interpretable product recommendations via overlapping co-clustering. IEEE 33rd International Conference on Data Engineering (ICDE) utilizes a clustering algorithm to check whether the users or items from the same cluster share similar characteristics. The exploratory approach requires manually searching for similarity through characteristics which entails coming up with hypotheses and evaluating them iteratively. Such a process is time consuming, and is subject to cognitive bias and to the significant risk of missing out on important underlying characteristic. In contrast, at least some implementations of the systems, methods, apparatus, and/or code instructions described herein utilizing semantic models to generate and evaluate many diverse hypotheses automatically.
Marco Rossetti, Fabio Stella, Markus Zanker. Towards Explaining Latent Factors with Topic Models in Collaborative Recommender Systems. 24th International Workshop on Database and Expert Systems Applications, and Liang Hu, Songlei Jian, Longbing Cao, Qingkui Chen. Interpretable Recommendation via Attraction Modeling: Learning Multilevel Attractiveness over Multimodal Movie Contents. Proceedings of the Twenty-Seventh International Joint Conference on Artificial Intelligence (IJCAI-18) both applied natural-language-processing techniques to extract information about the users and/or the entities. These processes however, only support information extraction from textual and categorical data. An unsupervised algorithm (LDA) is used to extract topics and it only matches movie latent factors to topics which are not semantically defined. Humans are used to manually select the best “tag cloud” for the movies.

In contrast, at least some implementations of the systems, methods, apparatus, and/or code instructions described herein provide a fully automated process, regardless of the data type, without a need for manual tatting, by extracting features for the users (e.g., from metadata) as described herein.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As used herein, the terms correlation and mapping may sometimes be interchanged.

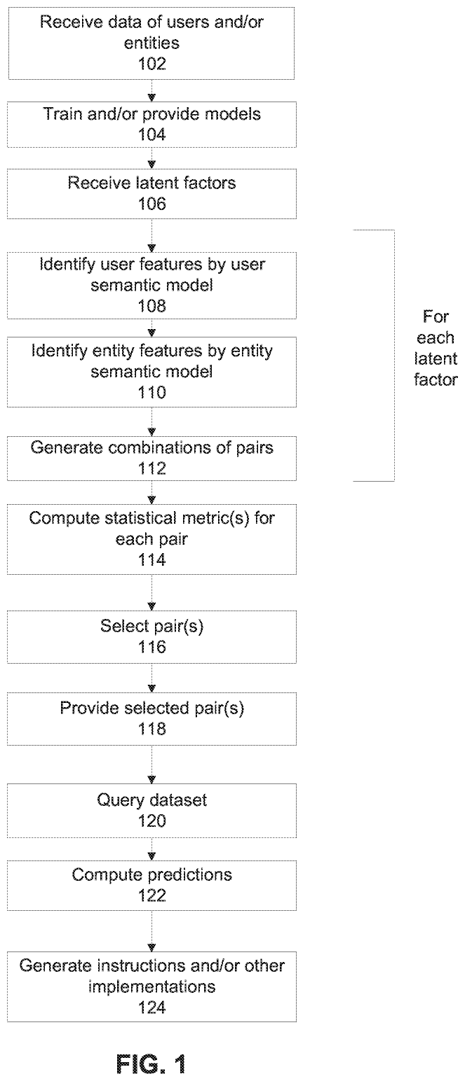

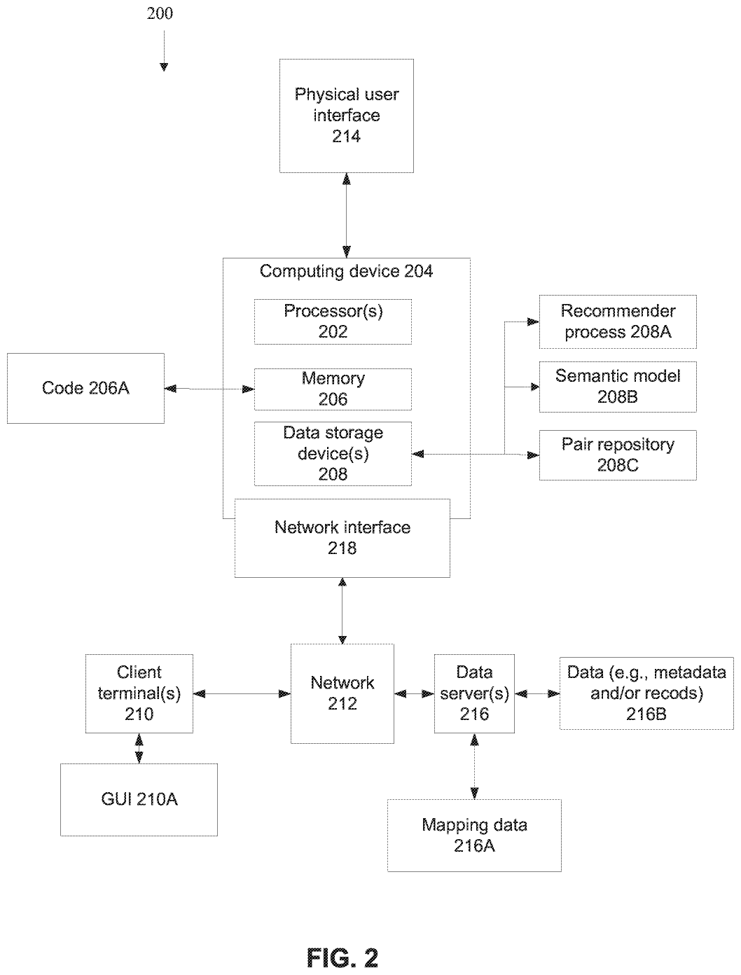

Reference is now made to FIG. 1, which is a flowchart of a method of selecting subpopulations of users mapped to subpopulations of entities, in accordance with some embodiments of the present invention. Reference is also made to FIG. 2, which is a block diagram of components of a system 200 for selecting subpopulations of users mapped to subpopulations of entities, in accordance with some embodiments of the present invention. System 200 may implement the acts of the method described with reference to FIG. 1, by processor(s) 202 of a computing device 204 executing code instructions (e.g., code 206A) stored in a memory 206 (also referred to as a program store).

Computing device 204 may be implemented as, for example one or more and/or combination of: a group of connected devices, a client terminal, a server, a virtual server, a computing cloud, a virtual machine, a desktop computer, a thin client, a network node, a network server, and/or a mobile device (e.g., a Smartphone, a Tablet computer, a laptop computer, a wearable computer, glasses computer, and a watch computer).

Different architectures of system 200 may be implemented. For example:
Computing device 204 may be implemented as one or more servers (e.g., network server, web server, a computing cloud, a virtual server, a network node) that provides services to multiple client terminals 210 over a network 212, for example, generation and/or selection of pairs of user features and entity features, as described herein.

Computing device 204 may receive values for parameters for generation and/or selections of pairs of user features from each client terminal 210 (e.g., threshold values, number of latent factors to use, number of pairs to identify, which statistical metric to use), generate the pairs, and provide the selected pairs to the respective client terminal 210. A graphical user interface (GUI) code 210A executed by client terminal 210 and/or executed by a web browser accessing computing device 204 may be used by a user to enter the data provided to computing device 204, and/or the selected pairs may be presented on a display of client terminal(s) 210 within GUI 210A. It is noted that GUI 210A may be executed by computing device 204 and/or presented on a display of computing device 204 (e.g., a physical user interface 214)
Computing device 204 may interface with a data server 216, for example, for obtaining mapping data 216A that maps between users and entities for computation of the latent factors, and/or data (e.g., metadata and/or records of users and/or entities) from which user features and/or entity features are extracted, as described herein. Communication between client terminal(s) 210 and/or data server(s) 216 and/or computing device 204 over network 212 may be implemented, for example, via an application programming interface (API), software development kit (SDK), functions and/or libraries and/or add-ons added to existing applications executing on client terminal(s) 210, an application for download and execution on client terminal(s) 210 and/or data server(s) 216 that communicates with computing device 204, function and/or interface calls to code executed by computing device 204, a remote access section executing on a web site hosted by computing device 204 accessed via a web browser executing on client terminal(s) 210 and/or data server(s) 216.
Computing device 204 may be implemented as a standalone device (e.g., client terminal, smartphone, computing cloud, virtual machine, kiosk, server) that includes locally stored code that implement one or more of the acts described with reference to FIG. 2. For example, computing device 204 obtains the mapping data 216A for computing the latent factors and/or data 216B for computation of the semantic model by accessing locally stored data (e.g., in data storage device 208) and/or accessing data server 216 over network 212, locally computes the pairs, and presents the selected pairs on a display (e.g., user interface 214).

Hardware processor(s) 202 of computing device 204 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 202 may include a single processor, or multiple processors (homogenous or heterogeneous) arranged for parallel processing, as clusters and/or as one or more multi core processing devices.

Memory 206 stores code instructions executable by hardware processor(s) 202, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Memory 206 stores code 206A that implements one or more features and/or acts of the method described with reference to one or more of FIGS. 1 and 3-5 when executed by hardware processor(s) 202.

Computing device 204 may include data storage device(s) 208 for storing data, for example, recommender process 208A for computing the latent factors according to mapping data 216A, semantic model 208B for computing user features and/or entity features based on data 216B (e.g., metadata and/or records) and/or pair repository 208C which stores the computes pairs. Data storage device(s) 208 may be implemented as, for example, a memory, a local hard-drive, virtual storage, a removable storage unit, an optical disk, a storage device, and/or as a remote server and/or computing cloud (e.g., accessed using a network connection).

Network 212 may be implemented as, for example, the internet, a broadcast network, a local area network, a virtual network, a wireless network, a cellular network, a local bus, a point to point link (e.g., wired), and/or combinations of the aforementioned.

Computing device 204 may include a network interface 218 for connecting to network 212, for example, one or more of, a network interface card, an antenna, a wireless interface to connect to a wireless network, a physical interface for connecting to a cable for network connectivity, a virtual interface implemented in software, network communication software providing higher layers of network connectivity, and/or other implementations.

Computing device 204 and/or client terminal(s) 210 include and/or are in communication with one or more physical user interfaces 214 that include a mechanism for user interaction, for example, to enter data (e.g., select number of latent factors to compute, define requirement for selection of pairs, select statistical metric(s) to use) and/or to view data (e.g., the user feature and the entity feature for each selected pair).

Exemplary physical user interfaces 214 include, for example, one or more of, a touchscreen, a display, gesture activation devices, a keyboard, a mouse, and voice activated software using speakers and microphone.

Client terminal(s) 210 and/or server(s) 216 may be implemented as, for example, as a desktop computer, a server, a virtual server, a network server, a web server, a virtual machine, a thin client, a cellular telephone, a smart phone, and a mobile device.

Referring now back to FIG. 1, at 102, data of users and/or entities is received.

Entities may be, for example, physical objects, physical services, virtual objects, and/or virtual services. Exemplary entities include: a physical product on a supermarket shelf, a cellular plan, a loan, a mortgage, an insurance policy, a stock, a website and/or a link to website, and an advertisement.

Users may be human based, for example, individual humans, a group of humans (e.g., an organization).

Users may be automated code based processes executed by processor(s), for example, an application, a machine user (e.g., code, such as automated purchasing code), machine learning code (e.g., classifier, neural network) and/or a virtual user.

Users may be physical, non-living entities, for example, a store. Features of the store (i.e., users) include, for example, store size, and/or store geographic location. Entities may be items sold in the stores, with one or more of the following exemplary attributes: brand, flavor, volume, and pack size (e.g., entity features). Data may be provided, for example, given on a weekly basis in the schema: date, store (i.e., user), item (i.e., entity), units sold, value. The collaborative filtering target may be the sum of yearly sales, or units for each store and item.

Entities may be computational resources used by automated code based processes, for example, a computational resource (e.g., processor), a memory resource, and a network resource (e.g., bandwidth).

Optionally, an indication of mapping between the users and entities is received. The mapping may include a correlation value between a certain user and a certain entity. The correlation value may be provided and/or computer for each combination of certain user and certain entity. It is noted that some pairs of users and entities may include undefined and/or unavailable correlation values. The correlation value may be indicative of an amount of correlation between the certain user and the certain entity, optionally a preference level for the certain entity by the certain user. Exemplary correlation values include and/or are based on: a rating value of the certain entity provided by the certain user (e.g., from 1 to 10), an amount of money the certain user spent purchasing the certain entity (i.e., amount of purchases) over a historical time interval, a number of purchases of the certain entity made by the certain user over a historical time interval, a number of times the certain user accessed the certain entity (e.g., number of times the user accessed a web page presenting the certain entity, number of clicks of a link and/or web page associated with the certain entity).

The data of the users, entities, and/or correlation values may be, for example, manually entered by a user, and/or obtained from an automated analysis of a dataset of records (e.g., analysis of purchases of entities by users).

Optionally, features for the users (referred to herein as user features) and/or features for the entities (referred to herein as entity features) are received. The user features and/or entity features may be provided, for example, manually entered by a user and/or automatically extracted based on an analysis of data (e.g., metadata, records) of the users and/or entities, for example, extracted from a database storing features of the users (e.g., demographic database, database of personal data entered by the users) and/or from a database storing features of the entities (e.g., catalogue of the entities describing their features, such as weight, length, country of manufacture, and the like) and/or automatically extracted by code that searches the internet to extract the information (e.g., accesses a social media web profile of the user to extract the features).

Exemplary user features, optionally for human based users, include: demographic data, geographic living location, geographic job location, purchase pattern of certain items (e.g., for other entities), occupation, age, education level, consumer behavior history (e.g., for other entities), socio-economic background, social media activity, social network characteristics, geographic location (such as for a seller, for example, city, neighborhood, proximity to different places such as restaurants, shopping centers, services), the size of the seller (e.g., number of employees, square feet of store space), seniority, performance, domain expertise, and an indication of the relationship between the user and the entity (e.g., purchaser, seller, distributor). It is noted that some user features may be relevant to one type of user but not to another type of user, for example, some features are relevant to purchasing users but not to selling users, and other features are relevant to selling users but not to purchasing users.

Exemplary user features, optionally for automated code based processes, include: executing processor model, complexity of code, network address, memory requirements, network bandwidth requirements, and type of code (e.g., application, machine learning, neural network, classifier, kernel processes).

Exemplary entity features include: price, prestige, promotion, and indication of physical and/or virtual availability, size and/or pack, materials, flavors, manufacturing date, design, duration, type, topic. It is noted that some entity features may be relevant to one type of entity but not to another type of entity, for example, some features are relevant to physical objects but not to services, and other features are relevant to services but not to physical objects.

Exemplary entity features, optionally for resources, include: processor availability, processor model, memory availability, and network bandwidth availability.

At 104, a user semantic model and/or an entity semantic model is received and/or trained (i.e., computed). The user semantic model and/or the entity semantic model may be provided, for example, from a memory storing code of the user semantic model and/or entity semantic model, and/or trained.

The user data and/or entity data may be embedded into two latent vector spaces, for example, using one or more of matrix factorization based processes, for example, as described with reference to one or more of: Yehuda Koren, Robert Bell, and Chris Volinsky. Matrix factorization techniques for recommender systems. 2009; Francesco Ricci, Lior Rokach, Bracha Shapira, and Paul B. Kantor. Recommender Systems Handbook. 1st edition, 2010; Yehuda Koren. Factor in the neighbors: scalable and accurate collaborative filtering. 2010; Daniel D. Lee and H. Sebastian Seung. Algorithms for non-negative matrix factorization. 2001; Xin Luo, Mengchu Zhou, Yunni Xia, and Qinsheng Zhu. An efficient non-negative matrix factorization-based approach to collaborative filtering for recommender systems. 2014; Sheng Zhang, Weihong Wang, James Ford, and Fillia Makedon. Learning from incomplete ratings using non-negative matrix factorization. 1996; and Ruslan Salakhutdinov and Andriy Mnih. Probabilistic matrix factorization. 2008, all of which are incorporated herein by reference in their entirety.

The semantic models may generate multiple hypotheses based on a wide range of functions given the data types, and validate the hypotheses against the values. The most significant and/or corroborated hypotheses may be selected as features, on top of which predictive models (e.g. XGBoost), may be built. Examples of generated hypotheses include whether the average or standard deviation, applied to time series (e.g., the user's purchase history), is above a certain threshold, and/or whether geo-coordinates of a user's address, is within a given district. These models are known as semantic, for example, as the hypotheses space that is being generated to build them may be easily interpreted and thus used to drive business actions.

The semantic model may be implemented as a machine learning model with features that may be transparent and/or explainable as possible. Exemplary semantic models include, for example, ““Why Should I Trust You?”: Explaining the Predictions of Any Classifier” by Marco Tulio Ribeiro, Sameer Singh, Carlos Guestrin, arXiv:1602.04938v3 [cs.LG]. Other exemplary semantic models, assigned to the same assignee of the present application, and including at least one common inventor, include: U.S. Pat. No. 9,324,041, application Ser. No. 15/165,059, application Ser. No. 15/165,015, and U.S. Pat. No. 9,753,968, all of which are incorporated herein by reference in their entirety.

At 106, latent factors are received. The latent factors are of the mapping between the users and the entities. The latent factors are predicted, for example, by a recommender process, for example, a collaborating filtering model.

The latent factors may represent a mapping between a set of user latent factors and a set of entity latent factors, within the same space, where the same latent factors represents a certain user latent factor and a corresponding entity latent factor. An example of latent factors is genres of movies (e.g., drama, comedy, action, etc). Each user may be associated with a set (e.g., vector) of values (i.e., user latent factors) each denoting how much the respective user likes each genre, for example, a rating from 1 to 10. For example, a certain user is associated with a set of user latent factors denoted as (drama=4, comedy=9, action=7). Similarly, each movie (i.e., entity) may be associated with a set of values (i.e., entity latent factors) denoting how strong the component of each respective genre is in it, for example, a rating from 1 to 10. For example a certain movie (i.e., entity) is associated with a set of entity latent factors denoted as (drama=8, comedy=6, action=2). Since the user latent factors correspond to the same entity latent factors, referred to herein a latent factor, the users and the movies are described using the same latent factor representation.

Optionally, one set of latent factors is provided for the users, and another set of latent factors is provided for the entities. The two sets of latent factors may correspond to one another, for example, a certain latent factor of the users corresponds to the same latent factor of the entities.

For users, each latent factor may provide an indication (e.g., measure) how much the user likes entities that score high on the corresponding entity latent factor. For entities, each latent factor may provide an indication (e.g., measure) how much the entity is liked by users that score high on the corresponding user latent factor. The identified latent factors may represent characterizing attributes that are common to the users and items that score high on that respective latent factor. The identified latent factors may represent attributes that are easier to infer, for example, the movie genre ‘Documentary’ when predicting the rating a user will give to a movie. They may also measure attributes that are less interpretable.

Optionally, the dataset (e.g., as described with reference to 102) includes predefined correlation values associated with the mapping of the users to the entities. Alternatively, there are no initially defined correlation values between users and entities. Optionally, the recommender process and/or other processes as described herein compute mappings and/or correlation values between the users and entities, for example, using external metadata such as a history of which user purchased which item.

Undefined mappings (i.e., where no mapping and/or correlation value is defined between a certain entity and a certain user) may be associated with (e.g., assigned) a predicted correlation value. The predicted correlation value for the undefined mappings may be computed, for example, by the recommender process. The recommender system is trained to predict the correlation values for undefined mappings of the dataset.

Optionally, the initial mappings and the predicted correlation values defined a mapping and/or correlation value between each one of the users and each one of the entities. Optionally, all users are mapped to all entities once processed by the recommender process.

The predicted correlation value assigned to the undefined mappings by the recommender system may correspond to correlation value of the defined mappings.

Optionally, the recommender model learns, for each respective user, a set (e.g., vector) of latent factors that represent the respective user, and for each entity a set (e.g., vector) of latent factors that represent the respective entity.

Optionally, the number of latent factors is set, for example, manually selected by a user (e.g., using a user interface), stored in a memory as a system setting, and/or automatically computed by code. The number of latent factors may be adjusted.

Optionally, the recommender process is set and/or adjustable, for example, manually selected by a user (e.g., using a user interface), stored in a memory as a system setting, and/or automatically computed by code.

Optionally, the process for training the recommender process is set and/or adjustable, for example, manually selected by a user (e.g., using a user interface), stored in a memory as a system setting, and/or automatically computed by code.

It is noted that 104 may be implemented after 106, together with 106, and/or with respect to one 108 and/or 110. For each respective latent factor, a user semantic model and/or an entity semantic model are each trained for predicting the respective latent factor.

Optionally, the latent factors include multiple user latent factors computed by the recommender model for the users, and multiple entity latent factors computed by the recommender model for the entities. For each respective user latent factor, the user semantic model for prediction of the respective user latent factor is computed. For each respective entity latent factor, the entity semantic model for prediction of the respective entity latent factor is computed. The user latent factors are mapped to the entity latent factors. The combination of pairs (e.g., as in 112) are generated for each of the latent factors mapping between a certain user latent factor and a certain entity latent factor.

Features 108-112 are implemented for each respective latent factor, sequentially and/or simultaneously (e.g., parallel processing):

At 108, user features for the users correlated to the respective latent factor are identified by the user semantic model trained for the respective latent factor. The user features express the common user characteristics.

Higher positive latent factor may correlate, for example, with: larger stores and/or proximity to sport facilities.

Lower negative latent factor may correlate, for example, with: proximity to competitor and/or store being located in lower socio-economic area.

Optionally, a correlation value indicative of strength of the correlation between each respective user feature and the respective latent factor is computed, for example, outputted by the respective user semantic model.

Optionally, a subset of the user features are selected. The subset of user features may be selected based on a ranking according to the strength of the respective correlation value to the respective latent factor. A top number of predefined user features may be selected. Alternatively or additionally, the user features having correlation above a threshold are selected.

At 110, entity features for the entities correlated to the respective latent factor are identified by the entity semantic model trained for the respective latent factor. The entity features express the common entity characteristics.

Higher positive latent factor may correlate, for example, with: small volumes and/or single packs.

Lower negative latent factor may correlate, for example, with: large volumes and/or family-size packs.

Optionally, a correlation value indicative of strength of the correlation between each respective entity feature and the respective latent factor is computed, for example, outputted by the respective entity semantic model.

Optionally, a subset of the entity features are selected. The subset of entity features may be selected based on a ranking according to the strength of the respective correlation value to the respective latent factor. A top number of predefined entity features may be selected. Alternatively or additionally, the entity features having correlation above a threshold are selected.

At 112, combinations of pairs each including one user feature and one entity feature are generated.

For example: Store (i.e., user) features correlated with high positive latent factor are matched with item (i.e., entity) features correlated with high positive latent factor. Store features correlated with low negative latent factor are matched with item features correlated with low negative latent factor. For example: A certain store is located in lower socio-economic area matched with family-size packages->contributes to higher latent factor. Another store is located near sport facilities matched with singles packaging->contributes to higher latent factor (since both are negative).

Optionally, the combinations are generated using the selected user features and entity features, for example, the top number of ranked user features identified by the user semantic model and the top ranked entity features identified by the entity semantic model.

Optionally, the number of user features from the user semantic model and/or the entity features from the entity semantic model used for generating the user-entity pairs are set and/or adjustable, for example, manually selected by a user (e.g., using a user interface), stored in a memory as a system setting, and/or automatically computed by code.

Optionally, the combinations are generated in a cross-product manner, where each pair includes one user feature and one entity feature that are originated and paired through the same latent factor.

At 114, for each pair, one or more statistical metrics are computed against the correlation value between the respective user feature and entity feature of the respective pair. Each statistical metric measures the difference in the corresponding correlation value. Each statistical metric is indicative of a change relative to the predicted and/or initial defined correlation value for the users and the entities.

For example, for each pair one or more of the following exemplary statistical metrics are calculated:
The support.
The mean shift in target and standard deviation ratio with respect to the entire population.
The mean shift in target and standard deviation ratio with respect to the population for which only the user feature is true.
The mean shift in target with respect to the population for which only the entity feature is true.
Any other metric with statistic significance.

The statistical metric may be mathematically denoted as:

E[Y|f,g]−E[Y]

where

E denotes the respective statistical metric (e.g. as described below, for example, average) taken over all user-item pairs

Y denotes a target, and

f,g denote a pair of a certain user feature and a certain entity feature

Exemplary statistical metrics include:
Preference-level mean shift: Computed as a change in a mean of the correlation value computed for a subset of the users and a subset of the entities for which the user feature and entity feature of the respective pair are true, relative to the users and entities.
User support: Computed as a percentage of a subset of the users for which the user feature of the respective pair are true.
Item support: Computed as a percentage of a subset of the entities for which the entity feature of the respective pair are true.
User's lift: Computed as a difference between a correlation value of the user to entities with the entity features of the respective pair, and a correlation value of the user to other entities that exclude the entity features of the respective pair.
Item's lift: Computed as a difference between a correlation value of the entity among the users with the user features of the respective pair, and a correlation value of the entity amount other users excluding the user features of the respective pair.

At 116, one or more pairs are selected according to a requirement of the statistical metric(s), for example, all pairs above a certain threshold of the metric(s) are selected, for example, denoting relationships between users and entities that are desired. Alternatively, all pairs below the certain threshold of the metric(s) are selected, for example, denoting relationships between users and entities that are undesirable. The statistical metric(s) may be aggregated into a single aggregated value used for selecting the pair(s), for example, an average, optionally a weighted average of the computed metric(s).

The pairs may be selected by sorting by one or a combination of the statistical metrics (e.g., support and mean shift), and selecting the top predefined number of pairs and/or pairs above a threshold.

The pairs may be ranked according to the value of the metric(s) and the top number of pairs are selected.

The selected pairs represent user-entity subpopulations for which the entity features and the user features identified in the pairs are assumed to be true (e.g., metric(s) above the threshold), or assumed to be false (e.g., metric(s) below the threshold).

At 118, the user feature and/or the entity feature for each selected pair are provided, for example, presented on a display, stored in a memory, provided to another computing device (e.g., remote device over a network), and/or provided to another executing process (e.g., application, function, library call) for further processing.

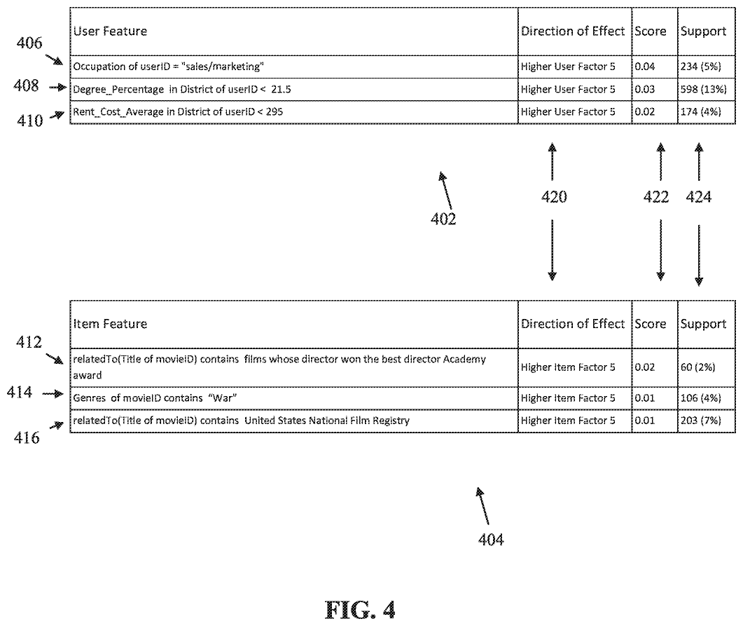

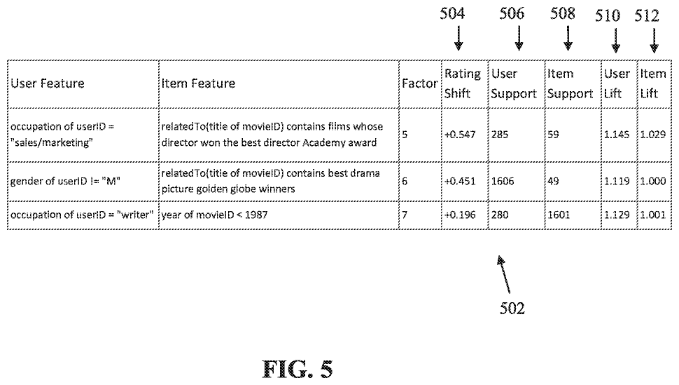

Optionally, the values of the metric(s) and/or corresponding pairs (e.g., user feature and/or entity feature) are presented on a display for interaction thereof, for example, within a graphical user interface (GUI), for example, as described herein with reference to FIGS. 4-5. The GUI provides iterations, for example, sorting according to a selected metric, exploring details of each pair, and/or defining threshold for selection of the pairs.

Optionally, the selected pairs are stored, for example, as a dataset. The dataset may be queried and/or used to compute predictions, and/or used to generate instructions, as described herein.

At 120, optionally, the dataset of selected pairs is queried. The query may represent a query for a matching between a certain user and/or a certain entity or group of certain users and/or group of certain entities). Alternatively or additionally, the query may represent a prediction for a correlation between a certain user and a certain entity (or group of certain users and/or group of certain entities).

Optionally, the query includes a target user feature denoting a subpopulation of users. For example, the query is the user feature: age >50. The query is executed on the dataset to identify a subset of one or more pairs that including the target user feature. The corresponding correlated target entity feature(s) from the identified subset are provided, for example, presented on a display, stored in a memory, forwarded to a remote device, and/or provided to another executing process for further processing. For example, for in response to the query, the entity feature black&white movie is retrieved.

Alternatively or additionally, the query includes a target entity feature denoting a subpopulation of entities. For example, the query is the entity feature: genre_of _movie=war. The query is executed on the dataset to identify a subset of one or more pairs that including the target entity feature. The corresponding correlated user entity feature(s) from the identified subset are provided, for example, presented on a display, stored in a memory, forwarded to a remote device, and/or provided to another executing process for further processing. For example, for in response to the query, the user feature occupation=sales/marketing is retrieved.

For example, the business is a store where most of the visiting customers are identified by certain features, for example, the customers are mostly of a certain age range, the customers live in a certain geographic location, and/or the customers are of a certain income group. Entity features associated with higher user lift (or other metrics) may be selected according to the user feature(s), as described herein. The store may promote the items (i.e., entities) characterized by the item features.

In another example, the business is a retailer. Selecting user features associated with higher item lift (or other metrics), as described herein, may help in optimizing items distribution among stores. The retailer may benefit more from distributing the items (i.e., entities), characterized by the entity feature, in particular among stores where most of the visiting customers are characterized by the user features.

Instructions may be generated according to the identified user feature and/or entity feature, for example, as described with reference to 124.

At 122, correlation values and/or latent factors are predicted for new users and/or new entities. The new entities and/or new users are provided, for example, including user features and/or entity features, as described with reference to 102, for example, as metadata. The dataset may be updated with the predicted correlation values, and optionally queried, and/or pairs selected using the updated dataset.

The prediction of the latent factors for the new entities and/or new users may improve the personalized recommendations for the new users and/or for the new entities, for example, which new entities correspond to existing and/or new users, and/or which new users correspond to existing and/or new entities.

The following are exemplary predictions:
A new user preference level for an existing entity, by placing the predicted values for user latent factors as input to the recommender model,
An existing user preference level for a new entity, by placing the predicted values for entity latent factors as input to the same recommender model.
A new user preference level for a new entity, by placing the predicted values for user latent factors and the predicted values for entity latent factors as input to the recommender model.

Additional details for exemplary predictions are now provided:

Optionally, the trained user semantic model is used to predict latent factors and/or correlation values between new user(s) and existing entities. The latent factors and/or correlation values may be used to predict one or more entities correlated with the new user(s). An indication of a new user may be received and fed into the user semantic model. The user semantic model output a predicted value of the respective latent factor correlated with the new user. A new correlation value for a mapping between the new user and one or more existing entities is outputted (e.g., computed) the by recommender process in response to feeding the prediction of the value of the respective latent factor outputted by the user semantic model as input into the recommender process.

Alternatively or additionally, the trained entity semantic model is used to predict latent factors and/or correlation values between new entities and existing user(s). The latent factors and/or correlation values may be used to predict one or more users correlated with the new entity (or entities).

An indication of a new entity may be received and fed into the entity semantic model. The entity semantic model output a predicted value of the respective latent factor correlated with the new entity. A new correlation value for a mapping between the new entity and one or more an existing users is outputted (e.g., computed) the by recommender process in response to feeding the prediction of the value of the respective latent factor outputted by the entity semantic model as input into the recommender process.

Alternatively or additionally, the user semantic model and the entity semantic model are used to predict latent factors and correlation values between new user(s) and/or existing user(s) and/or new entities (or entity) and/or existing entities. The latent factors and/or correlation values may be used to predict one or more new and/or existing users correlated with the one or more new and/or existing entity (or entities). An indication of a new user is received and fed into the user semantic model, which outputs a prediction value of the respective latent factor. An indication of a new entity is received and fed into the entity semantic model for prediction of a value of the respective latent factor. A new correlation value for a mapping between the new user and the new existing entity is outputted by the recommender process in response to feeding the prediction of the value of the respective latent factor as input into the recommender process.

At 124, instructions may be generated based on the output of 118 and/or 120 and/or 122. The instructions may be, for example, code for execution by one or more processors, and/or instructions for manual implementation by a user. The manual instructions may be provided, for example, presented on a display, played as audio instructions, and/or presented as a 3D virtual reality presentation.

One or more of the following may be implemented, for example, in a client terminal, a server, and/or a mobile recommendation prediction application, by generating instructions:
A store owner wants to select items which are more likely to be sold in high quantities. Instructions are generated to find pairs with attributes matching those of the store, and stock items with associated attributes.
An item production company wants to promote certain items. Instructions are generated to find pairs with attributes matching those of the items, and promote them in stores with associated attributes.
A store chain wants to select items for promotions. Instructions are generated to promote specific items in specific stores based on attributes of pairs.

In another example, instructions may be to automatically sends ads for the identified entities to the identified users. In another example, instructions may be to automatically allocate identified computational resources to the identified executing code processes. In another example, instructions may be to automatically present GUIs depicting the identified entities on displays used by the identified users.

In another example, where the users are executing code processes and the entities are computational resources, code instructions are generated for automatically assigning the difference code processes for execution by respective computational resources.

Alternatively or additionally, implementations (e.g., actions) are performed based on the output of 118 and/or 120 and/or 122. For example, a user may derive manual actions and/or program automated actions from the selected pairs utilizing domain knowledge and/or business objectives.

For example, based on the selected pair(s), a business may perform actions to promote the sub-set of items corresponding to the identified entity features of the selected pair(s) to target the sub-population of users corresponding to the identified user features of the selected pair(s). For example, new campaigns may be tailored, and/or new items may be designed for different user populations.

Following the examples described above, the instructions may be for the store to promote the items (i.e., entities) characterized by the item features. In another example described above, the instructions may be for the retailer, for distributing the items among stores where most of the visiting customers have the user features.

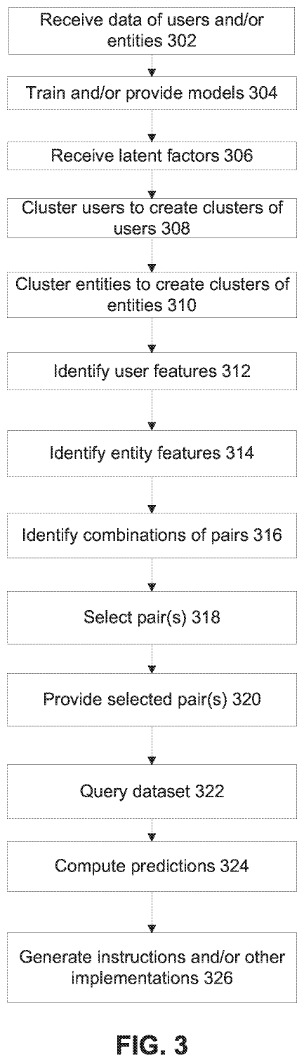

Reference is now made to FIG. 3, which is a flowchart of another method of selecting subpopulations of users mapped to subpopulations of entities, in accordance with some embodiments of the present invention. The method described with reference to FIG. 3 may include, combine, and/or substitute features of the method described with reference to FIG. 1. The method described with reference to FIG. 3 may be implemented by components of the system described with reference to FIG. 2.

At 302, data of users and/or entities and/or user features, and/or entity features are provided, for example, as described with reference to 102 of FIG. 1.

At 304, semantic models and/or recommender models are provided and/or trained, for example, as described with reference to 104 of FIG. 1.

At 306, latent factors are computed. User latent factors are computed for the users by the recommender model. Entity latent factors are computed for the entities by the recommender model. For example, as described with reference to 106 of FIG. 1.

At 308, users are clustered to create clusters of users. The clustering may be performed according to user latent factors of the users, for example, all users corresponding to the same user latent factor are assigned to a common cluster. The clustering may be performed according to correlation values between the respective users and entities, for example, all users corresponding to the same correlation values (e.g., within a range and/or according to another requirement) of the same entities are assigned to the same cluster.

A suitable clustering algorithm (e.g. k-means) may be used to cluster users based on their latent space embeddings. The number of clusters may be determined, or for example, algorithmically (e.g., Gap Statistic, as described with reference to Robert Tibshirani, Guenther Walther, and Trevor Hastie, Estimating the number of clusters in a dataset via the gap statistic, J. R. Statis. Soc B (2001) 63, Part 2, pp. 441-423, interactively (e.g., Density Peaks, as described with reference to Alex Rodriguez, Alessandro Laio, Clustering by fast search and find of density peaks, Science 27 Jun. 2014: Vol. 344, Issue 6191, pp. 1492-1496 and/or Domain knowledge (e.g., store manager or store chain CXO), all of which are incorporated herein by reference in their entirety.

At 310, entities are clustered to create clusters of entities. The clustering may be performed according to entity latent factors of the entities, for example, all entities corresponding to the same entity latent factor are assigned to a common cluster. The clustering may be performed according to correlation values between the respective entities and users, for example, all entities corresponding to the same correlation values (e.g., within a range and/or according to another requirement) of the same users are assigned to the same cluster.

Clustering may be performed as described with reference to 308, using entities and corresponding embeddings.

It is noted that the number of entity clusters have nothing to do with the number of user clusters.

At 312, user features explaining user cluster assignment are identified. The identified user features may be common to all (or most, or according to requirement) users of the same cluster. The user features may be found for each one of the user clusters. For example, stores (i.e., users) in user-cluster #1 have a bigger size and are located closer to sport facilities relative to stores in other user-clusters. Stores in user-cluster #4 have a smaller size and are located in lower socio-economic areas relative to stores in other user-clusters.

The user features may be found, for example, by feeding the user into the user semantic model as described with reference to FIG. 1.

At 314, entity features explaining entity cluster assignment are identified. The identified entity features may be common to all (or most, or according to requirement) entities of the same cluster. The entities features may be found for each one of the entity clusters. For example, Items in item-cluster #2 are of a certain brand and sell in higher columns than items in other item-clusters. Items in item-cluster #5 are usually in family-sized packs and have a sweet flavor more than items in other item-clusters.

The entity features may be found, for example, by feeding the entity into the entity semantic model as described with reference to FIG. 1.

At 316, pairs of clusters are identified. Each pair includes one cluster of users and one cluster of entities. The pairs may be identified by correlations between clusters of users and clusters of entities, for example, highly positive correlations or highly negative correlations. The correlations may be computed, for example, as a statistical distance between the cluster of users and the cluster of entities within a space. For example, the entity cluster that is closest (or furthest) from each user cluster is selected and paired. In another example, the user cluster that is closest (or furthest) from each entity cluster is selected and paired.

For each user cluster—entity cluster pair, one or more of the following exemplary statistical metrics may be calculated:
The support.
The mean shift in target and standard deviation ratio with respect to the entire population.
The mean shift in target and standard deviation ratio with respect to the population for which users belong to the user-cluster.
The mean shift in target and standard deviation ratio with respect to the population for which items belong to the item-cluster.
The mean shift in target and standard deviation ratio with respect to the population for which users belong to the user-cluster and items belong to the item-cluster.
Any other metric with statistic significance.

At 318, one or more pairs may be selected, for example, as described with reference to 116, by adapting to user-cluster and item-cluster pairs instead of user-feature and entity-feature pairs. The pairs may be selected, for example, by computing a statistical metric(s) for each pair (e.g., as described with reference to 114 of FIG. 1), and/or selecting the pairs based on the statistical metric(s) (e.g., as described with reference to 116 of FIG. 1).

At 320, the selected pair(s) are provided, for example, as described with reference to 118 of FIG. 1.

At 322, the dataset based on the data of the pair(s) may be queried, for example, as described with reference to 120 of FIG. 1.

At 324, predictions are computed, for example, as described with reference to 122 of FIG. 1.

At 326, instructions may be generated and/or other implementations implemented, for example, as described with reference to 124 of FIG. 1.

Various embodiments, implementations, and aspects of systems, methods, apparatus, and/or code instructions as delineated hereinabove and as claimed in the claims section below find calculated support in the following examples.

### EXAMPLES

Reference is now made to the following examples, which together with the above descriptions illustrate some implementations and/or embodiments of the systems, methods, apparatus, and/or code instructions described herein in a non limiting fashion.

Inventors implemented at least some embodiments of the systems, methods, apparatus, and/or code instructions described, using pairs of user and movies. Users assigned ratings to the movies.

Reference is now made to FIG. 4, which includes a table 402 depicting exemplary user features computed for users correlated to latent factor 5 by a computed user semantic model, and a table 404 depicting exemplary entity features computed for entities correlated to latent factor 5 by a computed entity semantic model, in accordance with some embodiments of the present invention.

Tables 402 and 404 may be presented within a GUI, optionally an interactive GUI, as described herein.

The latent factors were computed using a collaborative filtering model trained to predict the correlation value (e.g., preference level) as measured by the rating a user gives to a movie (i.e., the entity).

The features express common characteristics for users and items with high values in latent factor 5.

Column 420 (for tables 402 and 404) denotes “Direction of Effect” which are higher and lower when the feature is positively and negatively correlated with the latent factor respectively.

Column 422 (for tables 402 and 404) denotes “Score”, which is the statistical metric representing the correlation between the feature and the latent factor, as described herein.

Column 424 (for tables 402 and 404) denotes “Support”, which is the number and percentage of users in table 402 or entities in tables 404 for which the respective feature holds.

Based on table 402 the user features indicate that users working in sales or marketing (row 406), and living in districts with a lower degree (row 408) and renting rates (row 410) are more likely to have high values of latent factor 5.

Based on table 404, the entity features indicate that award-winning (row 412) US movies (row 414) about wars (row 416) are more likely to have high values of latent factor 5.

Reference is now made to FIG. 5, which includes a table 502 of pairs each including a certain user feature and a certain entity feature, in accordance with some embodiments of the present invention. The user features and entity features were presented independently in FIG. 4. The top 3 ranking pairs are presented along with values of respective statistical metrics presented in columns 504-512: rating shift 504, user support 506, item support 508, user lift 512, and item lift 512. The top 3 ranking pairs are sorted based on values of the Rating Mean Shift 504. The feature pair that ranked first originated from the two models predicting latent factor 5.

Table 502 may be presented within a GUI, optionally an interactive GUI, for example, enabling sorting by a certain metric, as described herein.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant recommenders systems will be developed and the scope of the term recommender system is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method of selecting subpopulations of users mapped to subpopulations of entities, comprising:
receiving a plurality of latent factors of a mapping between a plurality of users and a plurality of entities and a predicted correlation value for each undefined mapping, computed by a recommender process;
for each respective latent factor:
identifying, by a computed user semantic model, a plurality of user features of the plurality of users correlated to the respective latent factor;
identifying, by a computed entity semantic model, a plurality of entity features of the plurality of entities correlated to the respective latent factor;
generate combinations of pairs each including one user feature and one entity feature;
for each pair, computing at least one statistical metric indicative of a change relative to the predicted correlation value for the plurality of users and the plurality of entities;
selecting at least one pair according to a requirement of the at least one statistical metric; and
providing the user feature and the entity feature for each selected at least one pair.

2. The method of claim 1, wherein the at least one statistical metric is computed as a change in a mean of the correlation value computed for a subset of the plurality of users and a subset of the plurality of entities for which the user feature and entity feature of the respective pair are true, relative to the plurality of users and the plurality of entities.

3. The method of claim 1, wherein the at least one statistical metric is computed as a percentage of a subset of the plurality of users for which the user feature of the respective pair are true.

4. The method of claim 1, wherein the at least one statistical metric is computed as a percentage of a subset of the plurality of entities for which the entity feature of the respective pair are true.

5. The method of claim 1, wherein the at least one statistical metric is computed as a difference between a correlation value of the user to entities with the entity features of the respective pair, and a correlation value of the user to other entities that exclude the entity features of the respective pair.

6. The method of claim 1, wherein the at least one statistical metric is computed as a difference between a correlation value of the entity among the users with the user features of the respective pair, and a correlation value of the entity amount other users excluding the user features of the respective pair.

7. The method of claim 1, further comprising:
receiving a target user feature denoting a subpopulation of users;
identifying a subset of the at least one pair including the target user feature; and
providing at least one target entity feature from the identified subset.

8. The method of claim 1, further comprising:
receiving a target entity feature denoting a subpopulation of entities;
identifying a subset of the at least one pair including the target entity feature; and
providing at least one target user feature from the identified subset.

9. The method of claim 1, further comprising:
receiving an indication of a new user, feeding the indication of the new user into the user semantic model for prediction a value of the respective latent factor;
computing a new correlation value for a mapping between the new user and an existing entity, by feeding the prediction of the value of the respective latent factor as input into the recommender process.

10. The method of claim 1, further comprising:
receiving an indication of a new entity, feeding the indication of the new entity into the entity semantic model for prediction of a value of the respective latent factor;
computing a new correlation value for a mapping between the new entity and an existing user, by feeding the prediction of the value of the respective latent factor as input into the recommender process.

11. The method of claim 1, further comprising:
receiving an indication of a new user, feeding the indication of the new user into the user semantic model for prediction a value of the respective latent factor;
receiving an indication of a new entity, feeding the indication of the new entity into the entity semantic model for prediction of a value of the respective latent factor;
computing a new correlation value for a mapping between the new user and the new existing entity, by feeding the prediction of the value of the respective latent factor as input into the recommender process.

12. The method of claim 1, wherein the plurality of latent factors include a plurality of user latent factors computed by the recommender process for the plurality of users and a plurality of entity latent factors computed by the recommender process for the plurality of entities;
for each respective user latent factors of the plurality of user latent factors, computing the user semantic model for prediction of the respective user latent factor;
for each respective entity latent factors of the plurality of entity latent factors, computing the entity semantic model for prediction of the respective entity latent factor;
mapping the plurality of user latent factors to the plurality of entity latent factors;
wherein the combination of pairs are generated for each of the plurality of latent factors mapping between a certain user latent factor and a certain entity latent factor.

13. The method of claim 1, further comprising, for each respective latent factor:
computing a respective correlation value for each one of the plurality of user features and the respective latent factor,
selecting a subset of the plurality of user features according to a requirement of the respective correlation value,
computing a correlation value for each one of the plurality of entity features and the respective latent factor,
selecting a subset of the plurality of entity features according to a requirement of the respective correlation value,
wherein the combinations of pairs are generated from the selected subset of the plurality of entity features and the subset of the plurality of user features.

14. The method of claim 1, wherein the correlation value predicted by the recommender process is selected from the group consisting of: a rating value assigned by the target user to the target entity, amount of purchases over a historical time interval by the target user of the target entity, value of purchases over a historical time interval by the target user of the target entity, number of clicks by the target user of a link and/or web page associated with the target entity.

15. The method of claim 1, wherein the mapping includes predefined correlation values associated with the mapping of the plurality of users to the plurality of entities, and the recommender system is trained to predict the correlation values for undefined mappings.

16. The method of claim 1, wherein the plurality of entities are selected from the group consisting of: a physical object, an item, a service, a computational resource, a network resource, a product, a cellular plan, a loan, a mortgage, an insurance policy, a stock, a website, a link to a web site, and an advertisement.

17. The method of claim 1, wherein the plurality of user features for users representing human or organizations are selected from the group consisting of: demographic data, geographic living location, geographic job location, purchase pattern of certain items, occupation, age, education level, consumer behavior history, socio-economic background, social media activity, social network characteristics, geographic location, city, neighborhood, proximity to different places, number of employees, physical store size, seniority, performance, and domain expertise; wherein the plurality of user features for users representing automated code based processes are selected from the group consisting of: executing processor model, complexity of code, network address, memory requirements, network bandwidth requirements.

18. The method of claim 1, wherein the plurality of entity features are selected from the group consisting of: size of an item, categorical description, genre, price, prestige, promotion, physical size, materials, flavors, manufacturing date, country of manufacture, design, duration of service or program, type of service or program, topic of service or program, processor availability, processor model, memory availability, and network bandwidth availability.

19. A system for selecting subpopulations of users mapped to subpopulations of entities, comprising:
at least one hardware processor executing a code for:
receiving a plurality of latent factors of a mapping between a plurality of users and a plurality of entities and a predicted correlation value for each undefined mapping, computed by a recommender process;
for each respective latent factor:
identifying, by a computed user semantic model, a plurality of user features of the plurality of users correlated to the respective latent factor;
identifying, by a computed entity semantic model, a plurality of entity features of the plurality of entities correlated to the respective latent factor;
generating combinations of pairs each including one user feature and one entity feature;
for each pair, computing at least one statistical metric indicative of a change relative to the predicted correlation value for the plurality of users and the plurality of entities;
selecting at least one pair according to a requirement of the at least one statistical metric; and
providing the user feature and the entity feature for each selected at least one pair.

20. A method of selecting subpopulations of users mapped to subpopulations of entities, comprising:
receiving a mapping between plurality of user latent factors of a plurality of users and a plurality of entity latent factors of a plurality of entities and a predicted correlation value for each undefined mapping, computed by a recommender process;
clustering users to create clusters of users according to corresponding user latent factors;
clustering entities to create clusters of entities according to corresponding entity latent factors;
identifying a plurality of user features common to users of each cluster of users;
identifying a plurality of entity features common to entities of each cluster of entities;
identifying pairs according to correlations between clusters of users and clusters of entities, each pair including a certain cluster of users and a certain cluster of entities;
selecting at least one pair; and
providing at least one user feature and at least one entity feature for each selected at least one pair.

21. The method of claim 20, wherein the users are clustered to create clusters of users according to correlations between each user and entities, and the entities are clusters to create clusters of entities according to correlations between each entity and users.
